(19) United States
(12) Patent Application Publication
(10) Pub. No.: US 2026/0132252 A1
(43) Pub. Date: May 14, 2026

(54) LIQUID POLYETHYLENE GLYCOLS

(71) Applicants: Dow Global Technologies LLC, Midland, MI (US); Rohm and Haas Company, Collegeville, PA (US)

(72) Inventors: Matthew E. Belowich, Phoenixville, PA (US); Xue Chen, Manvel, TX (US); Clark H. Cummins, Midland, MI (US); Yujing Tan, Midland, MI (US)

(21) Appl. No.: 19/121,164

(22) PCT Filed: Oct. 11, 2023
(86) PCT No.: PCT/US2023/076551

§ 371 Date: Apr. 15, 2025

Related U.S. Application Data
(60) Provisional application No. 63/417,335, filed on Oct. 19, 2022.

(51) Int. Cl. C08G 65/26

(52) U.S. Cl. CPC C08G 65/2648

(57) ABSTRACT

A method of producing polyethylene glycol includes the steps of combining a tetra(ethylene glycol) initiator and one or more catalysts selected from the group consisting of MOH and MH to form a reaction mixture, wherein M is selected from the group consisting of an alkali metal and an alkaline earth metal, further wherein the reaction mixture comprises 1200 ppm or less of water as measured according to Karl Fischer Titration; adding ethylene oxide to the reaction mixture; and reacting the reaction mixture to form polyethylene glycol having a weight average molecular weight from 200 g/mol to 1000 g/mol as measured according to Gas Chromatography with Mass Spectrometry Detection.

### BACKGROUND

### Field of the Disclosure

The present disclosure is directed to methods of making polyethylene glycol and more specifically to methods of making liquid polyethylene glycol compositions having low tri (ethylene glycol) concentrations.

### INTRODUCTION

Polyethylene glycols having a weight average molecular weight from 200 grams per mole (“g/mol”) to 1000 g/mol are useful in pharmaceuticals and in the formation of products intended for consumption by humans. Such low molecular weight polyethylene glycols are traditionally formed by combining ethylene oxide, an initiator and a catalyst in a reactor until the products polymerize into polyethylene glycol. Given the usage, certain jurisdictions have begun imposing regulatory standards on residual materials in the polyethylene glycols. For example, China has implemented a regulatory requirement that residual tri (ethylene glycol) (“TEG”) in polyethylene glycol should be less than 1000 parts per million (“ppm”) as measured according to Gas Chromatography with Flame Ionization Detection.

The source of residual TEG in low molecular weight polyethylene glycol is not fully understood and there are several competing hypotheses about the origin. One hypothesis regarding residual TEG concentrations is related to the use of TEG as an initiator for the polyethylene glycol. For example, it is hypothesized that some of the TEG is left unreacted and results in the residual TEG exceeding regulatory targets. The residual TEG explanation is particularly problematic for low molecular weight polyethylene glycols as TEG has comparatively similar size to the final product and therefore is expected to comprise a greater percentage of the final product. Put another way, it is more likely in low molecular weight polyethylene glycols for initiators such as TEG to remain unreacted. Various attempts at using other initiators have been attempted. U.S. Pat. No. 4,946,939A describes the production of high purity polyether polyols using different initiators such as diethylene glycol, triethylene glycol tetra(ethylene glycol) in conjunction with water and then filters unwanted low molecular weight components (i.e., TEG) out using membrane filtration. Similarly, CN106905522A describes the use of diethylene glycol, triethylene glycol and tetraethylene glycol in the production of polyethylene glycols having a molecular weight of 8,000 g/mol or greater using a composite calcium-based catalyst.

As TEG levels in low molecular weight polyethylene glycol remains a problem, manufacturers have resorted to removing the TEG after the formation of the polyethylene glycol. Traditional methods of removing TEG from polyethylene glycol includes separate distillation and/or separation steps. While effective, the introduction of additional steps not only complicates manufacturing of the polyethylene glycol, but it also increases the final cost and time required to produce the polyethylene glycol. As such, there exists a need in the art for a method of forming polyethylene glycols with reduced TEG concentrations directly without further purification steps.

In view of the foregoing, it would be surprising to discover a method of producing polyethylene glycol having a weight average molecular weight from 200 g/mol to 1000 g/mol as measured according to Gas Chromatography with Mass Spectrometry Detection which has 1000 ppm or less of TEG as measured according to Gas Chromatography with Flame Ionization Detection.

### SUMMARY OF THE DISCLOSURE

The inventors of the present application have discovered a method of producing polyethylene glycol having a weight average molecular weight from 200 g/mol to 1000 g/mol as measured according to Gas Chromatography with Mass Spectrometry Detection which has 1000 ppm or less of TEG as measured according to Gas Chromatography with Flame Ionization Detection.

The present disclosure is a result of discovering that while selection of an initiator having a greater molecular weight than TEG is important (i.e., tetra(ethylene glycol)), the removal of water during the manufacturing of the polyethylene glycol is also important. Without being bound by theory, it is believed that the presence of water tends function as an initiator to ring open ethylene oxide to form ethylene glycol. Due to the relatively low molecular weight (i.e., 200 g/mol to 1000 g/mol) of the polyethylene glycol, some of the ethylene glycol formed during ring opening are ultimately polymerized into TEG and push the resulting product beyond its regulatory targets. It has been discovered that by limiting the water concentration in the combined ethylene oxide, initiator, and catalyst reaction mixture to 1200 ppm or less that the resulting polyethylene glycol exhibits a TEG concertation of 1000 ppm or less as measured according to Gas Chromatography with Flame Ionization Detection.

The present disclosure is particularly advantageous in the formation of glycol compositions.

According to a first feature of the present disclosure, a method of producing polyethylene glycol, comprises the steps combining a tetra(ethylene glycol) initiator and one or more catalysts selected from the group consisting of MOH and MH to form a reaction mixture, wherein M is selected from the group consisting of an alkali metal and an alkaline earth metal, further wherein the reaction mixture comprises 1200 ppm or less of water as measured according to Karl Fischer Titration; adding ethylene oxide to the reaction mixture; and reacting the reaction mixture to form polyethylene glycol having a weight average molecular weight from 200 g/mol to 1000 g/mol as measured according to Gas Chromatography with Mass Spectrometry Detection.

According to a second feature of the present disclosure, the step of reacting the reaction mixture further comprises reacting the reaction mixture to form polyethylene glycol having a weight average molecular weight from 300 g/mol to 600 g/mol as measured according to Gas Chromatography.

According to a third feature of the present disclosure, the polyethylene glycol has a triethylene glycol concentration of less than 1000 ppm as measured according to Gas Chromatography with Flame Ionization Detection.

According to a fourth feature of the present disclosure, the polyethylene glycol has a triethylene glycol concentration of 500 ppm or less as measured according to Gas Chromatography with Flame Ionization Detection.

According to a fifth feature of the present disclosure, the step of reacting the reaction mixture further comprises heating the reaction mixture to a temperature ranging from 120° C. to 150° C.

According to a sixth feature of the present disclosure, the catalyst is KOH.

According to a seventh feature of the present disclosure, the method further comprises the step of dehydrating the initiator prior to combination with the one or more catalysts.

According to an eighth feature of the present disclosure, the method further comprises the step of dehydrating the combined initiator and the one or more catalysts.

According to a ninth feature of the present disclosure, the reaction mixture comprises 800 ppm or less of water as measured according to Karl Fischer Titration.

According to a tenth feature of the present disclosure, the reaction mixture comprises 500 ppm or less of water as measured according to Karl Fischer Titration.

### DETAILED DESCRIPTION

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

All ranges include endpoints unless otherwise stated.

As used herein, the term weight percent (“wt %”) designates the percentage by weight a component is of a total weight of the glycol composition unless otherwise specified.

As used herein, Chemical Abstract Services registration numbers (“CAS #”) refer to the unique numeric identifier as most recently assigned as of the priority date of this document to a chemical compound by the Chemical Abstracts Service.

Unless otherwise denoted, all molecular weight measurements herein are determined according to Gas Chromatography with Mass Spectrometry Detection as explained below.

### Method

The present disclosure is directed to a method of producing polyethylene glycol. The method includes a step of combining a tetra(ethylene glycol) initiator and one or more catalysts selected from the group consisting of MOH or MH to form a reaction mixture. M is selected from the group consisting of an alkali metal and an alkaline earth metal. The reaction mixture comprises 1200 ppm or less of water as measured according to Karl Fischer Titration as explained in greater detail below. The method also includes a step of adding ethylene oxide to the reaction mixture. The method also includes a step of reacting the reaction mixture to form polyethylene glycol having a weight average molecular weight from 200 g/mol to 1000 g/mol as measured according to Gas Chromatography with Mass Spectrometry Detection. The method may also include a step of dehydrating the initiator prior to combination with the one or more catalysts. The method may also include a step of dehydrating the combined initiator and the one or more catalysts. It will be understood that the steps of the method can be performed in any order and/or simultaneously, where practicable. The steps relating to adding and combining the initiator, catalysts and ethylene oxide may be performed in a reactor or in a separate container for later transfer to a reactor.

### Reaction Mixture

The reaction mixture comprises tetra(ethylene glycol), one or more catalysts, and ethylene oxide. The reaction mixture, prior to the addition of ethylene oxide, comprises 1200 ppm of water or less as measured according to Karl Fischer Titration as explained in greater detail below. For example, the reaction mixture may comprise 1200 ppm or water or less, or 1150 ppm of water or less, or 1100 ppm of water or less, or 1050 ppm of water or less, or 1000 ppm or less, or 950 ppm or less, or 900 ppm or less, or 850 ppm or less, or 800 ppm or less, or 750 ppm or less, or 700 ppm or less, or 650 ppm or less, or 600 ppm or less, or 550 ppm or less, or 500 ppm or less, or 450 ppm or less, or 400 ppm or less, or 350 ppm or less, or 300 ppm or less, or 250 ppm or less, or 200 ppm or less, or 150 ppm or less, or 100 ppm or less, or 50 ppm or less as measured according to Karl Fischer Titration. As ethylene oxide does not contain significant amounts of water, the reaction mixture may comprise the above-noted water concentrations either before or after the addition of ethylene oxide to the reaction mixture.

### Tetra(Ethylene Glycol) Initiator

The initiator used in the method is tetra(ethylene glycol) (“TTEG’). As explained above, utilizing TTEG as an initiator aids in the reduction of TEG in the final polyethylene glycol by eliminating one of the hypothesized sources of TEG. TTEG has a CAS # of 112-60-7 and a chemical formula of C₈H₁₈O₅. The reaction mixture may comprise from 40 wt % to 60 wt % of TTEG based on the total weight of the reaction mixture including ethylene oxide. For example, the reaction mixture can comprise 40 wt % or greater, or 42 wt % or greater, or 44 wt % or greater, or 46 wt % or greater, or 48 wt % or greater, or 50 wt % or greater, or 52 wt % or greater, or 54 wt % or greater, or 56 wt % or greater, or 58 wt % or greater, while at the same time, 60 wt % or less, or 58 wt % or less, or 56 wt % or less, or 54 wt % or less, or 52 wt % or less, or 50 wt % or less, or 50 wt % or less, or 48 wt % or less, or 46 wt % or less, or 44 wt % or less, or 42 wt % or less of the TTEG based on the total weight of the reaction mixture including ethylene oxide.

### Catalysts

Catalysts are used to catalyze the alkoxylation reaction between the initiator and the ethylene oxide thereby producing the polyethylene glycol. The catalysts are selected from the group consisting of MOH or MH, wherein M selected from the group consisting of an alkali metal and an alkaline earth metal. For example, M may be lithium, sodium, potassium, rubidium, cesium, francium, beryllium, magnesium, calcium, strontium, barium, and combinations thereof. As indicated, the alkali metal or an alkaline earth metal may be in the hydride and/or hydroxide form.

The catalyst may take a variety of forms. For example, the catalyst may be in an aqueous solution form, a power form and/or pellet form. In aqueous solution examples, the catalyst may be 30 wt % or greater, or 35 wt % or greater, or 40 wt % or greater, or 45 wt % or greater, or 50 wt % or greater, or 55 wt % or greater, or 60 wt % or greater, or 65 wt % or greater, or 70 wt % or greater, or 75 wt % or greater, or 80 wt % or greater, or 85 wt % or greater, or 90 wt % or greater of the catalyst bases on a total weight of the aqueous solution.

The reaction mixture may comprise from 0.01 wt % to 10 wt % catalyst based on the total weight of the reaction mixture including ethylene oxide. For example, the reaction mixture may comprise 0.01 wt % or greater, or 0.2 wt % or greater, or 0.3 wt % or greater, or 0.4 wt % or greater, or 0.5 wt % or greater, or 1.0 wt % or greater, or 1.5 wt % or greater, or 2.0 wt % or greater, or 2.5 wt % or greater, or 3.0 wt % or greater, or 3.5 wt % or greater, or 4.0 wt % or greater, or 4.5 wt % or greater, or 5.0 wt % or greater, or 5.5 wt % or greater, or 6.0 wt % or greater, or 6.5 wt % or greater, or 7.0 wt % or greater, while at the same time, 7.5 wt % or less, or 7.0 wt % or less, or 6.5 wt % or less, or 6.0 wt % or less, or 5.5 wt % or less, or 5.0 wt % or less, or 4.5 wt % or less, or 4.0 wt % or less, or 3.5 wt % or less, or 3.0 wt % or less, or 2.5 wt % or less, or 2.0 wt % or less, or 1.5 wt % or less, or 1.0 wt % or less, or 0.5 wt % or less, or 0.1 wt % or less of the catalyst based on the total weight of the reaction mixture including ethylene oxide.

### Ethylene Oxide

Ethylene oxide has a CAS # of 75-21-8 and has a chemical structure of C₂H₄O. In the presence of a catalyst, ethylene oxide is can be polymerized onto the TTEG initiator to form polyethylene glycol. Such a reaction is generally referred to as alkoxylation. The reaction mixture may comprise from 40 wt % to 60 wt % of ethylene oxide based on the total weight of the reaction mixture. For example, the reaction mixture can comprise 40 wt % or greater, or 42 wt % or greater, or 44 wt % or greater, or 46 wt % or greater, or 48 wt % or greater, or 50 wt % or greater, or 52 wt % or greater, or 54 wt % or greater, or 56 wt % or greater, or 58 wt % or greater, while at the same time, 60 wt % or less, or 58 wt % or less, or 56 wt % or less, or 54 wt % or less, or 52 wt % or less, or 50 wt % or less, or 50 wt % or less, or 48 wt % or less, or 46 wt % or less, or 44 wt % or less, or 42 wt % or less of the ethylene oxide based on the total weight of the reaction mixture.

### Dehydration

The method may comprise one or more dehydrating steps. The dehydration steps are designed to reduce and/or eliminate water present in the reaction mixture (i.e., with or without the ethylene oxide). For example, the method may include a step of dehydrating the initiator prior to combination with the one or more catalysts. Additionally or alternatively, the method may include a step of dehydrating the initiator prior to combination with the one or more catalysts. Additionally or alternatively, the method may include a step of dehydrating the combined initiator, catalyst and ethylene oxide.

Dehydration of the reaction mixture may be accomplished through a variety of means. For example, the reaction mixture may be heated to a temperature of 80° C. or greater, or 100° C. or greater, or 120° C. or greater, or 140° C. or greater, or 160° C. or greater, or 180° C. or greater, while at the same time, 200° C. or less, or 180° C. or less, or 160° C. or less, or 140° C. or less, or 120° C. or less, or 100° C. or less to aid in the removal of water. In another example, the dehydration procedures may reduce the pressure (i.e., create a vacuum) over the reaction mixture to 66.6 Pa or less, or 60 Pa or less, or 50 Pa or less, or 40 Pa or less or 30 Pa or less, or 20 Pa or less, or 10 Pa or less, or 7 Pa or less to help drive water out of the initiator and/or the catalyst. The dehydration procedures may also include agitation such as from an impeller, stir bar or the like. The dehydration procedures may include heat, reduced pressure and/or agitation in combination with one another.

### Reacting the Reaction Mixture

As explained above, the method produces a polyethylene glycol. Polyethylene glycol is a compound having Structure (I)

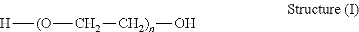

where n refers to the number of repeat units in the polyethylene glycol polymer. The n value for the polyethylene glycol may be in a range from 4 to 17 as determined by ¹³C nuclear magnetic resonance. The polyethylene glycol has a weight average molecular weight from 200 g/mol to 1000 g/mol as measured according to Gas Chromatography with Mass Spectrometry Detection. For example, the weight average molecular weight of the polyethylene glycol may be 200 g/mol or greater, or 250 g/mol or greater, or 300 g/mol or greater, or 350 g/mol or greater, or 400 g/mol or greater, or 450 g/mol or greater, or 500 g/mol or greater, or 550 g/mol or greater, or 600 g/mol or greater, or 650 g/mol or greater, or 700 g/mol or greater, or 750 g/mol or greater, or 800 g/mol or greater, or 850 g/mol or greater, or 900 g/mol or greater, or 950 g/mol or greater, while at the same time, 1000 g/mol or less, or 950 g/mol or less, or 900 g/mol or less, or 850 g/mol or less, or 800 g/mol or less, or 750 g/mol or less, or 700 g/mol or less, or 650 g/mol or less, or 600 g/mol or less, or 550 g/mol or less, or 500 g/mol or less, or 450 g/mol or less, or 400 g/mol or less, or 350 g/mol or less, or 300 g/mol or less, or 250 g/mol or less as measured according to Gas Chromatography with Mass Spectrometry Detection.

The polyethylene glycol has a triethylene glycol concentration of less than 1000 ppm as measured according to Gas Chromatography with Flame Ionization Detection. For example, the polyethylene glycol may have a triethylene glycol concentration of 999 ppm or less, or 950 ppm or less, or 900 ppm or less, or 850 ppm or less, or 800 ppm or less, or 750 ppm or less, or 700 ppm or less, or 650 ppm or less, or 600 ppm or less, or 550 ppm or less, or 500 ppm or less, or 450 ppm or less, or 400 ppm or less, or 350 ppm or less, or 300 ppm or less as measured according to Gas Chromatography with Flame Ionization Detection.

The polyethylene glycol is produced via an alkoxylation reaction in a stainless-steel reactor. The reactor is a vessel capable of holding pressure and heating (either via an internal or an external heating element) the reaction mixture until the ethylene oxide present polymerizes on the TTEG initiator. The alkoxylation process may be carried out at a pressure of 0.07 mega pascals (“MPa”) to 0.7 MPa. The process may be carried out under an inert environment such as nitrogen, a noble gas, etc. The alkoxylation process may be carried out at a temperature of 100° C. or greater, or 120° C. or greater, or 140° C. or greater, or 160° C. or greater, or 180° C. or greater, or 200° C. or greater, or 220° C. or greater, or 240° C. or greater, or 260° C. or greater, or 280° C. or greater, while at the same time, 300° C. or less, or 280° C. or less, or 260° C. or less, or 240° C. or less, or 220° C. or less, or 200° C. or less, or 180° C. or less, or 160° C. or less, or 140° C. or less, or 120° C. or less. As such, the step of reacting the reaction mixture may further comprise a step of heating the reaction mixture 120° C. to 150° C. The alkoxylation process may involve stirring of the reaction mixture using an impeller at a speed of 1 Revolutions Per Minute (“RPM”) to 2000 RPM to agitate the reaction mixture. The alkoxylation reaction may be carried out for a time period of 30 minutes to 4 hours depending on the quantities of raw materials used in the reaction mixture. The reaction mixture may optionally have an acid (e.g., phosphoric acid) added to the reaction mixture near the end of the alkoxylation process in order to neutralize the catalyst.

### EXAMPLES

### Materials

The following materials were used in the preparation of the comparative examples (“CE”) and the inventive examples (“IE”).

DEG is di(ethylene glycol) having a CAS # of 111-46-6, had a water concentration of 318 ppm as measured according to Karl Fischer Titration and was used as an initiator. The DEG was obtained from The Dow Chemical Company, Midland, MI.

TEG is tri (ethylene glycol) having a CAS # of 111-27-6, had a water concentration of 363 ppm as measured according to Karl Fischer Titration and was used as an initiator. The DEG was obtained from The Dow Chemical Company, Midland, MI.

TTEG is tetra(ethylene glycol) having a CAS # of 112-60-7, had a water concentration of 338 ppm as measured according to Karl Fischer Titration and was used as an initiator. The DEG was obtained from The Dow Chemical Company, Midland, MI.

KOHP is potassium hydroxide pellets having a CAS # of 1310-58-3 and was used as a catalyst. The KOHP was obtained from Sigma Aldrich, St. Louis, MO.

AQKOH is an aqueous solution of 45 wt % potassium hydroxide in water and was used as a catalyst. The AQKOH was obtained from Sigma Aldrich, St. Louis, MO.

KH is potassium hydride having a CAS # of 7693-26-7 and was used as a catalyst. The KH was obtained from Sigma Aldrich, St. Louis, MO.

EO is ethylene oxide having a 99.9% purity and a water content of less than 25 ppm which is available from Balchem Corporation, Newhapton, New York.

CAC is a calcium-based catalyst. The CAC was prepared according to the procedure in patent CN106905522A. Specifically, potassium hydroxide and calcium hydroxide were ground to a fine powder using a mortar and pestle. The powders were transferred to a 1-oz glass scintillation vial containing a magnetic stir-bar. With stirring, concentrated sulfuric acid was added dropwise such that the final molar ratio is 2:7:1 KOH:Ca(OH)₂:H₂SO₄. The resulting solid was dried in a vacuum oven (0.1 MPa) at 50° C. overnight.

Phosphoric acid had a purity of 85 wt % in water and was obtained from Sigma Aldrich, St. Louis, MO.

### Water Content of Catalyst Materials

To determine the amount of water introduced into the reactor by the catalyst, the known values in the Table 1 below were used.

TABLE 1

| Material | mg H₂O/g of catalyst |
|---|---|
| AQKOH | 550 |
| KOHP | 125 |
| KH | 0 |

Gas Chromatography with Flame Ionization Detection Method (“GCFID”)

### Internal Standard Solution Preparation:

The internal standard solution was prepared by weighing 0.1 g of 1,3-butanediol into a jar and adding methanol up to a total weight of 25 g. The solution was then mixed by hand to combine.

### Calibration Standard Stock Solution Preparation:

The calibration standard stock solution was prepared by weighing 0.1 g each of ethylene glycol, diethylene glycol and triethylene glycol into a single jar and adding methanol up to a total weight of 25 g, recording all weights. The solution was mixed by hand to combine.

### Calibration Standard Preparation:

The calibration standard was prepared by weighing 0.1 g of the calibration standard stock solution into a 20-mL vial and then weighing in 0.1 g of the internal standard solution. Then 9.8 g of methanol was weighed into the vial and the solution was placed on a flat-bed shaker for five minutes to mix.

### GCFID Sample Preparation:

GCFID Samples were prepared by weighing 0.4 g of a sample into a 20-mL vial and then weighing in 0.1 g of the internal standard solution. Then 9.5 g of methanol was weighed into the vial and the solution was placed on a flat-bed shaker for a few minutes to mix. Samples and standards were ran using the instrument conditions identified in Table 2 below:

TABLE 2

| Instrument: | Agilent 7890A Gas Chromatograph | |
|---|---|---|
| Detector: | Flame Ionization Detector | |
| Column: | Restek RXI-17Sil-MS 30 m × 0.25 mm × 0.25 μm | |
| Column Mode: | Constant Flow | |
| Column Flow: | 1.0 | mL/min |
| Carrier Gas: | Helium | |
| FID Temperature: | 290° | C. |
| FID Air Flow: | 450 | mL/min |
| FID Hydrogen Flow: | 40 | mL/min |
| FID Makeup Flow (He): | Constant Makeup at 40 mL/min | |
| Data Acquisition Rate: | 20 | Hz |
| Oven: | 60° C. Hold 2 mins, 10° C./min to 180° C., No Hold, | |
| | 35° C./min to 340° C., Hold 10 mins | |
| Run Time: | 28.571 | minutes |
| Inlet Temperature: | 270° | C. |
| Split Ratio: | 10:1 | |
| Septum Purge: | 4 | mL/min |
| Injection Volume: | 1 | μL |

| | |
|---|---|
| Wash Solvent: | Methanol |
| Number of Solvent Washes: | 3 Pre, 3 Post |
| Number of Sample Washes: | 4 |
| Number of Sample Pumps: | 4 |

Gas Chromatography with Mass Spectrometry Detection (GC/MS)

The same samples were used from the GC/FID analysis for the GC/MS analysis. The samples were analyzed using the conditions in Table 3:

TABLE 3

| GC conditions | | |
|---|---|---|
| GC system | Thermo Trace 1310 GC System | |
| Analytical column | RTX-5MS 30 m × 0.25 mm × 0.25 um | |
| Inlet Type | Split/Splitless | |
| Inlet Pressure | 10.007 | psi |
| Split flow | 120.0 | mL/min |
| Septum purge flow | 4 | mL/min |
| Split Ratio | 100:1 | |
| Inlet Temperature | 250° | C. |
| Injection Volume | 1 | μL |
| Column flow | 1.2 mL/min, constant flow | |
| GC Oven | 35° C. hold for 2.00 min, 10° C./ | |
| | min to 325° C. hold for 5.00 min | |
| GC Run Time | 36.00 | minutes |
| MS System | Thermo Q-Exactive Orbitrap | |
| MS Parameters | | |
| Mode | EI | |
| Transfer line temperature | 250° | C. |
| MS Source | 230° C. (EI) | |
| Reagent Gas (PCI Only) | N/A | |
| Reagent Gas Flow (PCI Only) | N/A | |
| Mass range | 50-750 m/z (EI) | |
| Energy | 70 | eV |
| Emission Current | 50.0 | μA |

| | |
|---|---|
| Solvent delay | Not used |
| Resolution | 60,000 |
| Microscans | 1 |
| AGC Target | 1e6 |
| Maximum IT | Auto |
| Spectrum Data Type | Profile |

### Karl Fischer Titration

Standard Coulometric Karl Fischer titration was performed in duplicate using a Metrohm 852 TITRANDO™ titrator with a Metrohm 803 Ti stand. The coulometric cell contained 175 mL of HYDRANAL™ Coulomat E solution. A Metrohm indicator electrode and Metrohm generator electrode without diaphragm were used. Metrohm TIAMO software was used for instrument control and data analysis. A Mettler-Toledo model AE 240 balance, capable of weighing to 0.0001 g was used. Prior to analysis the system was checked for accuracy using multiple injections of 2.0 μL of water. The system was also checked after the analysis with an injection of 2.0 μL of water. Recoveries were in the acceptable 98-102% range. Sample sizes of ˜3500 mg were used. Range-finding to determine the appropriate injection quantity consumed the entire triethylene glycol (TEG) sample of ˜20 g. Table 4 provides the standard coulometric Karl Fisher Titration method parameters:

TABLE 4

| Titrator | | | Titration Parameters | | |
|---|---|---|---|---|---|
| General/Hardware | | | Extraction time | 1000 | sec |
| Device Type | 852 Titrando, 803 Ti | | Temperature | 25 | C. |
| | Stand | | | | |
| Generator Type | Without diaphragm | | Time interval measuring | 1 | sec |
| | | | point | | |
| Generator Current | 400 | mA | Stop time | Off | |
| Stirring rate | 5 | | | | |
| | | | Conditioning | | |
| Start Conditions | | | Conditioning | On | |
| Pause | 20 | sec | Start Drift | 20 | μL/min |
| | | | Drift correction | Off | |
| Control Parameters | | | Stop time | Off | |
| Endpoint | 250 | mV | Stabilizing time | 0 | sec |
| Dynamics | 100 | mV | | | |
| Max Rate | 5 | mL/min | | | |
| Min vol increment | Minimum | | | | |
| Stop criterion | Drift | | | | |
| Relative stop drift | 20 | μL/min | | | |

The Karl Fischer Titration procedure was carried out according to the following procedure steps. First, a sample is drawn into a 5 mL BD Luer Lock syringe with a 16G×3⅛″ needle. Next, the balance was tared with the filled syringe. Next, the start button was pressed on the TIAMO™ software and the sample was injected through the septum port directly into the titrant. Next, the empty syringe is weighed to the nearest 0.0001 g. Next, the empty syringe mass value is multiplied by 1000 and the mass was entered into the Metrohm TIAMO™ software. Finally, the calculated concentration of water in the sample as ug/g (ppm) is reported.

### Sample Preparation

In preparation of the samples, two separate dehydration procedures were used. Where no dehydration procedure is identified, no dehydration procedure was performed. Post dehydration procedure, Karl Fischer Titration was performed to determine the water content of the reaction mixture. Where no dehydration procedure is outlined, the water concentration was calculated using the known water contents of the raw materials.

Dehydration Procedure A: In a nitrogen filled glovebox, the initiator (50-100 g) was weighed into a 240 mL glass jar containing a Teflon stir bar and heated to 120° C. with stirring while under vacuum (i.e., less than 66.6 Pa). After 24 hours of heating and stirring, the initiator was allowed to cool to 23° C. and an aliquot was removed for Karl Fischer titration. The designated catalyst was the added to the remaining portion of initiator with stirring resuming until the mixture was visually homogenous. The initiator/catalyst mixture was then used as indicated.

Dehydration Procedure B: Initiator (50-100 g) was weighed into a 240 mL glass jar containing a Teflon stir bar. The AQKOH was added to the initiator with stirring. The jar was capped and brought into a nitrogen filled glovebox where it was heated to 120° C. and stirred for 24 hours while under vacuum (i.e., less than 66.6 Pa). After 24 hours, the stirring and heating was halted and the combined catalyst and initiator were allowed to cool to 23° C. Once cooled, an aliquot was removed for Karl Fischer titration. The remaining portion of initiator/catalyst mixture was used as indicated.

General Alkoxylation Procedure: A 300 mL pressure stainless-steel reactor equipped with a pneumatically driven gas entrainment impeller, thermocouple, cooling water coils, baffles, a dip tube (6.35 mm outside diameter) that was connected to a nitrogen line, a monomer feed line and a vent using a four-way Swagelok fitting, and an aluminum heating block, was used. The 300 mL reactor was charged with the indicated initiator and catalyst which combined was measured for water concentration using Karl Fisher Titration and the reactor pressure is checked by feeding approximately 0.14 MPa of nitrogen and holding the pressure for 10 minutes. After verifying that the reactor did not have any leaks, the initiator and catalyst mixture was purged with nitrogen for 10 minutes without stirring. Then, the reactor was loaded with 0.14 MPa of nitrogen and heated to the indicated reaction temperature with stirring by the impeller set at 1000 rpm. Once the temperature stabilized for 5 minutes, ethylene oxide was fed into the reactor at a rate of 0.5 mL/minute. Once all of the ethylene oxide was fed into the reactor, the reaction temperature was maintained for an additional 2 hours with stirring to digest the residual ethylene oxide. Finally, the reactor was cooled to 50° C., the stirring was shut off, the reactor was vented, and 0.04 g of 85 wt % phosphoric acid was added to the product. The reactor was closed and stirred at 1,000 rpm for 5 minutes to disperse the acid before collecting the final product.

CE1: Following the general alkoxylation procedure, 0.20 g of a 45% aqueous solution of KOH was added to 40.0 g of DEG. The reactor was heated to 150° C. and 122.7 mL of EO was fed at a rate of 0.5 mL/minute yielding 142.0 g of a pale-yellow liquid.

CE2: Following the general alkoxylation procedure. 0.20 g of a 45% aqueous solution of KOH was added to 56.8 g of TEG. The reactor was heated to 150° C. and 104 mL of EO was fed at a rate of 0.5 mL/minute yielding 142.7 g of a pale-yellow liquid.

CE3: Following the general alkoxylation procedure, 0.20 g of a 45% aqueous solution of KOH was added to 73.6 g of TTEG. The reactor was heated to 150° C. and 85.6 mL of EO was fed at a rate of 0.5 mL/minute yielding 144.0 g of a pale-yellow liquid.

CE4: Following the general alkoxylation procedure, 0.15 g of calcium catalyst was added to 29.1 g of DEG. The reactor was heated to 150° C. and 99.6 mL of EO was fed at a rate of 0.5 mL/minute yielding 112.0 g of a pale-yellow liquid.

CE5: Following the general alkoxylation procedure, 0.20 g of a 45% aqueous solution of KOH was added to 56.8 g of TEG. The reactor was heated to 120° C. and 104 mL of EO was fed at a rate of 0.5 mL/minute yielding 142.4 g of a pale-yellow liquid.

CE6: Following the general alkoxylation procedure, 102 mg of KOH pellets was added to 65.0 g of TEG. The reactor was heated to 120° C. and 104 mL of EO was fed at a rate of 0.5 mL/minute yielding 142.3 g of a pale-yellow liquid.

CE7: Following the general alkoxylation procedure, 52 mg of KOH pellets was added to 33.0 g of TEG. The reactor was heated to 120° C. and 104 mL of EO was fed at a rate of 0.5 mL/minute yielding 142.3 g of a pale-yellow liquid.

CE8: Following the general alkoxylation procedure, 64 mg of KH was added to 57.0 g of TEG. The reactor was heated to 150° C. and 104 mL of EO was fed at a rate of 0.5 mL/minute yielding 142.7 g of a pale-yellow liquid.

CE9: Following the general alkoxylation procedure, 64 mg of KH was added to 57.0 g of TEG. The reactor was heated to 120° C. and 104 mL of EO was fed at a rate of 0.5 mL/min yielding 142.7 g of a pale-yellow liquid.

CE10: Following the general alkoxylation procedure, 64 mg of KH was added to 28.5 g of TEG. The reactor was heated to 120° C. and 56.9 mL of EO was fed at a rate of 0.5 mL/minute yielding 74.5 g of a pale-yellow liquid.

CE11: Following the general alkoxylation procedure, 73 mg of KH was added to 32.5 g of TEG. The reactor was heated to 150° C. and 59.6 mL of EO was fed at a rate of 0.5 mL/minute yielding 73.4 g of a pale-yellow liquid.

CE12: Following the general alkoxylation procedure, 52 mg of KH was added to 30.0 g of TTEG. The reactor was heated to 150° C. and 38.7 mL of EO was fed at a rate of 0.5 mL/minute yielding 55.4 g of a pale-yellow liquid.

CE13: 32.0 g of TTEG was dried according to dehydration procedure A. Then, 160 mg of calcium catalyst was added to the initiator and the general alkoxylation procedure was followed. The reactor was heated to 150° C. and 37.1 mL of EO was fed at a rate of 0.5 mL/minute yielding 59.4 g of a pale-yellow liquid.

CE14: For this reaction, 36 μL of water was added to 36.8 g of TTEG which was treated with dehydration procedure A. The water concentration measured by Karl Fisher titration was 1,533 ppm. Then, the general alkoxylation procedure was followed. The reactor was heated to 120° C. and 42.6 mL of EO was fed at a rate of 0.5 mL/minute yielding 70.4 g of a pale-yellow liquid.

IE1: 36.8 g of TTEG was dried according to dehydration procedure A. Then, 45 mg of ground up KOH pellets was added to the TTEG initiator and the mixture was stirred for 10 min until homogenous. The general alkoxylation procedure was followed. The reactor was heated to 120° C. and 42.6 mL of EO was fed at a rate of 0.5 mL/minute yielding 69.4 g of a pale-yellow liquid.

IE2: 36.8 g of TTEG was dried according to dehydration procedure A. Then, 32 mg of KH powder was added to the initiator and the general alkoxylation procedure was followed. The reactor was heated to 150° C. and 47.3 mL of EO was fed at a rate of 0.5 mL/minute yielding 73.2 g of a pale-yellow liquid.

IE3: Following dehydration procedure B, 36.8 g of TTEG containing KOH catalyst (0.42 mol %) was prepared. Then, the general alkoxylation procedure was followed. The reactor was heated to 120° C. and 42.6 mL of EO was fed at a rate of 0.5 mL/minute yielding 69.0 g of a pale-yellow liquid.

IE4: Following dehydration procedure B, 36.8 g of TTEG containing KOH catalyst (0.42 mol %) was prepared, and 4 μL of water was added to the TTEG/KOH mixture. The total water concentration measured by Karl Fischer titration was 281 ppm. Then, the general alkoxylation procedure was followed. The reactor was heated to 150° C. and 42.6 mL of EO was fed at a rate of 0.5 mL/minute yielding 70.8 g of a pale-yellow liquid.

IE5: Following dehydration procedure B, 36.8 g of TTEG containing KOH catalyst (0.42 mol %) was prepared, and 18 μL of water was added to the TTEG/KOH mixture. The total water concentration measured by Karl Fischer titration was 929 ppm. Then, the general alkoxylation procedure was followed. The reactor was heated to 150° C. and 42.6 mL of EO was fed at a rate of 0.5 mL/minute yielding 70.8 g of a pale-yellow liquid.

IE6: Following dehydration procedure B, 36.8 g of TTEG containing KOH catalyst (0.42 mol %) was prepared, and 18 μL of water was added to the TTEG/KOH mixture. The total water concentration measured by Karl Fischer titration was 929 ppm. Then, the general alkoxylation procedure was followed. The reactor was heated to 120° C. and 42.6 mL of EO was fed at a rate of 0.5 mL/minute yielding 70.4 g of a pale-yellow liquid.

### Results

Table 5 provides the residual TEG results based on the initiator used and the initial water concentration according to standard calibration.

TABLE 5

| | | | | Initial Water | | Residual |
|---|---|---|---|---|---|---|
| | | Temp | Dehydration | Concentration | | TEG |
| Ex. | Initiator | (° C.) | Procedure | (ppm)^{a} | Catalyst^{b} | (ppm) |
| CE1 | DEG | 150 | None | 2,750 | 45% aq. KOH | 4,424 |
| CE2 | TEG | 150 | None | 2,617 | 45% aq. KOH | 4,233 |
| CE3 | TTEG | 150 | None | 1,833 | 45% aq. KOH | 1,798 |
| CE4 | DEG | 150 | None | 37 | Ca Catalyst^{c} | 7,697 |
| CE5 | TEG | 120 | None | 2,617 | 45% aq. KOH | 2,600 |
| CE6 | TEG | 120 | None | 551 | KOH pellets | 1,757 |
| CE7 | TEG | 100 | None | 551 | KOH pellets | 1,791 |
| CE8 | TEG | 150 | None | 363 | KH | 2,043 |
| CE9 | TEG | 120 | None | 363 | KH | 1,832 |
| CE10 | TEG | 120 | None | 363 | KH^{d} | 1,637 |
| CE11 | TEG | 150 | None | 41 | KH | 9,407 |
| CE12 | TTEG | 150 | None | 1,833 | KH | 1,704 |
| IE1 | TTEG | 120 | A | 689 | KOH pellets | 519 |
| IE2 | TTEG | 150 | A | 117 | KH | 310 |
| CE13 | TTEG | 150 | A | 117 | Ca catalyst^{d} | 1,652 |
| IE3 | TTEG | 150 | B | 196 | 45% aq. KOH | 350 |
| IE4 | TTEG | 120 | B | 281 | 45% aq. KOH | 210 |
| IE5 | TTEG | 120 | B | 929 | 45% aq. KOH | 918 |
| IE6 | TTEG | 150 | B | 929 | 45% aq. KOH | 668 |
| CE14 | TTEG | 120 | B | 1,533 | 45% aq. KOH | 1,630 |

Table 6 provides the weight average molecular weight (“Mw”) of the different components of several polyethylene glycols produced and the associated weight percentages of each provided in Daltons (“Da”). The values in Table 6 were calculated by Gas Chromatography with Mass Spectrometry Detection and Flame Ionization Detection using peak area percentage.

TABLE 6

| Mw (Da) | IE3 | IE6 | IE5 | CE14 |
|---|---|---|---|---|
| 62 | 0.01 | 0.03 | 0.01 | 0.02 |
| 106 | 0.02 | 0.04 | 0.05 | 0.08 |
| 150 | 0.08 | 0.16 | 0.21 | 0.37 |
| 194 | 1.73 | 1.78 | 1.75 | 2.08 |
| 238 | 5.53 | 6.14 | 6.42 | 6.9 |
| 282 | 12.57 | 13.54 | 13.68 | 14.3 |
| 326 | 23.31 | 23.95 | 24.02 | 24.25 |
| 370 | 27.34 | 26.55 | 26.38 | 25.82 |
| 414 | 20.95 | 19.44 | 19.33 | 18.38 |
| 458 | 7.43 | 6.95 | 7.04 | 6.5 |
| 502 | 1.95 | 1.16 | 1.06 | 1.27 |

Referring now to Table 5 and 6, CE1-CE12 cumulatively demonstrate that reduced initial water content (i.e., 1200 ppm or less), catalyst and initiator all cannot independently be employed to reduce the presence of TEG in the final polyethylene glycol. For example, CE3 and CE12 demonstrate that TTEG used as an initiator alone cannot achieve the desired low TEG levels. CE1, CE2, and CE5-CE11 demonstrate that the catalyst alone or in combination with a reduced initial water content is not enough to achieve the target TEG concentrations in the final polyethylene glycol. CE13 demonstrates that TTEG as an initiator and a reduced initial water content will still produce unacceptable levels of TEG if a Ca based catalyst is used. Similarly, CE14 demonstrates that TTEG as an initiator and KOH as a catalyst will still produce unacceptable levels of TEG if the initial water content is above 1200 ppm.

Unlike the comparative examples, IE1-IE6 are all able to produce a polyethylene glycol having a weight average molecular weight from 200 g/mol to 1000 g/mol as measured according to Gas Chromatography with Mass Spectrometry Detection with 1000 ppm or less of TEG as measured according to Gas Chromatography with Flame Ionization Detection. As can be seen by IE1-IE6, utilizing TTEG as an initiator, one or more catalysts selected from the group consisting of MOH or MH (wherein M is one of an alkali metal or an alkaline earth metal) and ensuring the reaction mixture comprises 1200 ppm or less of water ensures that a polyethylene glycol is produced that has a TEG concentration of 1000 ppm or less as measured according to Gas Chromatography with Flame Ionization Detection.

1. A method of producing polyethylene glycol, comprising the steps:
combining a tetra(ethylene glycol) initiator and one or more catalysts selected from the group consisting of MOH and MH to form a reaction mixture, wherein M is selected from the group consisting of an alkali metal and an alkaline earth metal, further wherein the reaction mixture comprises 1200 ppm or less of water as measured according to Karl Fischer Titration;
adding ethylene oxide to the reaction mixture; and
reacting the reaction mixture to form polyethylene glycol having a weight average molecular weight from 200 g/mol to 1000 g/mol as measured according to Gas Chromatography with Mass Spectrometry Detection.

2. The method of claim 1, wherein the step of reacting the reaction mixture further comprises:
reacting the reaction mixture to form polyethylene glycol having a weight average molecular weight from 300 g/mol to 600 g/mol as measured according to Gas Chromatography.

3. The method claim 1, wherein the polyethylene glycol has a triethylene glycol concentration of less than 1000 ppm as measured according to Gas Chromatography with Flame Ionization Detection.

4. The method of claim 2, wherein the polyethylene glycol has a triethylene glycol concentration of 500 ppm or less as measured according to Gas Chromatography with Flame Ionization Detection.

5. The method of claim 1, wherein the step of reacting the reaction mixture further comprises heating the reaction mixture to a temperature ranging from 120° C. to 150° C.

6. The method of claim 1, wherein the catalyst is KOH.

7. The method of claim 1, further comprising the step of:
dehydrating the initiator prior to combination with the one or more catalysts.

8. The method of claim 1, further comprising the step of:
dehydrating the combined initiator and the one or more catalysts.

9. The method of claim 1, wherein the reaction mixture comprises 800 ppm or less of water as measured according to Karl Fischer Titration.

10. The method of claim 1, wherein the reaction mixture comprises 500 ppm or less of water as measured according to Karl Fischer Titration.
